(19) United States
(12) Patent Application Publication
(10) Pub. No.: US 2014/0119914 A1
(43) Pub. Date: May 1, 2014

(54) LOAD CONTROL SYSTEM AND METHOD

(71) Applicant: GENERAL ELECTRIC COMPANY, Schenectady, NY (US)

(72) Inventors: Sascha Schieke, Greer, SC (US); Bharat Bagepalli, Niskayuna, NY (US); Nilesh Tralshawala, Rexford, NY (US); Aditi Koppikar, Bangalore (IN); Pekka Sipilae, Munich (DE)

(73) Assignee: GENERAL ELECTRIC COMPANY, Schenectady, NY (US)

(21) Appl. No.: 13/666,349

(22) Filed: Nov. 1, 2012

(51) Int. Cl. F03D 7/04; G01H 7/00

(52) U.S. Cl. 416/1; 73/597; 416/31

(57) ABSTRACT

Load control systems and methods for shafts are provided. The load control system includes a sensor assembly. The sensor assembly includes a plurality of ultrasonic probes mounted to the shaft, each of the plurality of ultrasonic sensors configured to produce an ultrasonic wave on the shaft. The sensor assembly further includes a plurality of receivers mounted to the shaft, each of the plurality of receivers configured to sense the ultrasonic wave produced by one of the plurality of ultrasonic probes. The load control system further includes a controller communicatively coupled to the sensor assembly and configured to measure a travel time of the ultrasonic wave produced by each of the plurality of ultrasonic probes.

### FIELD OF THE INVENTION

The present disclosure relates generally to shafts, such as rotor shafts in wind turbines, and more particularly to load control systems and methods for controlling, for example, wind turbine loading.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and a rotor including one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

During operation of a wind turbine, various components of the wind turbine are subjected to various loads due to the aerodynamic wind loads acting on the blade. In particular, the shaft coupling the rotor blades and the generator may be subjected to various loads due to the wind loading acting on the rotor blades and resulting reaction loads being transmitted to the shaft. Such loading may include, for example, axial loads and moment loads, such as bending moment loads and torsional (twisting) moment loads. Deflection of the shaft due to these loads may thus frequently occur during operation of the wind turbine. When the loads are significantly high, substantial damage may occur to the rotor shaft, pillow blocks, bedplate and/or various other component of the wind turbine. Thus, the moment loads induced on the shaft due to such loading are particularly critical variable, and in many cases should desirably be controlled during operation of the wind turbine.

However, currently known systems and methods for controlling such loads, may not be accurate and/or may be poorly located. For example, proximity probes may be mounted to a flange on the shaft to monitor displacement. However, such probes must be mounted in relatively stable locations, which are typically in small, inaccessible areas, thus making it difficult to install and maintain the probes. Further, such probes require expensive, durable mounting hardware. Still further, the data provided by these probes provides only indirect measurements of the loads to which the shaft is subjected. These various disadvantages can result in inaccuracy and poor reliability. Additionally, many currently known systems and methods either cannot accurately distinguish between bending moment loads and torsional loads.

Thus, improved systems and methods for controlling loads in a wind turbine are desired. For example, systems and methods that provide more accurate and reliable measurements of shaft loading would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a load control system for a shaft. The load control system includes a sensor assembly. The sensor assembly includes a plurality of ultrasonic probes mounted to the shaft, each of the plurality of ultrasonic sensors configured to produce an ultrasonic wave on the shaft. The sensor assembly further includes a plurality of receivers mounted to the shaft, each of the plurality of receivers configured to sense the ultrasonic wave produced by one of the plurality of ultrasonic probes. The load control system further includes a controller communicatively coupled to the sensor assembly and configured to measure a travel time of the ultrasonic wave produced by each of the plurality of ultrasonic probes.

In another embodiment, the present disclosure is directed to a method for controlling wind turbine loading. The method includes producing an ultrasonic wave at a first end of a rotor shaft, sensing the ultrasonic wave, and calculating a rotor shaft torsional load based on a travel time of the transverse ultrasonic wave.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 illustrates a perspective, internal view of a nacelle of a wind turbine according to one embodiment of the present disclosure;

FIG. 3 illustrates a cross-sectional view of a shaft of a wind turbine according to one embodiment of the present disclosure;

FIG. 4 illustrates a cross-sectional view of a shaft of a wind turbine according to another embodiment of the present disclosure; and

FIG. 5 is a front view of a hub flange of a shaft according to one embodiment of the present disclosure;

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

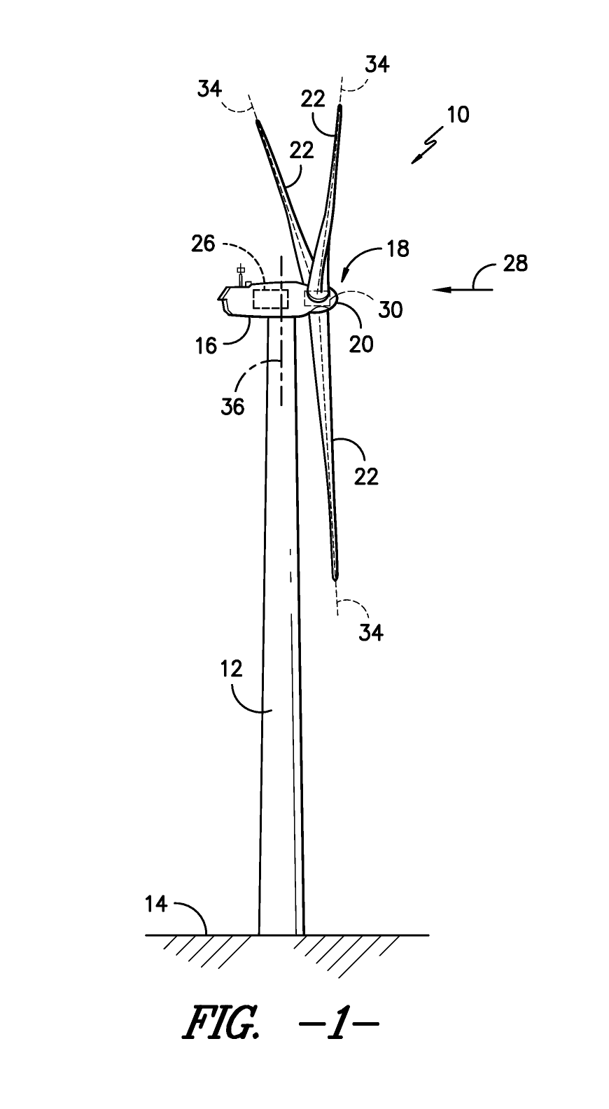

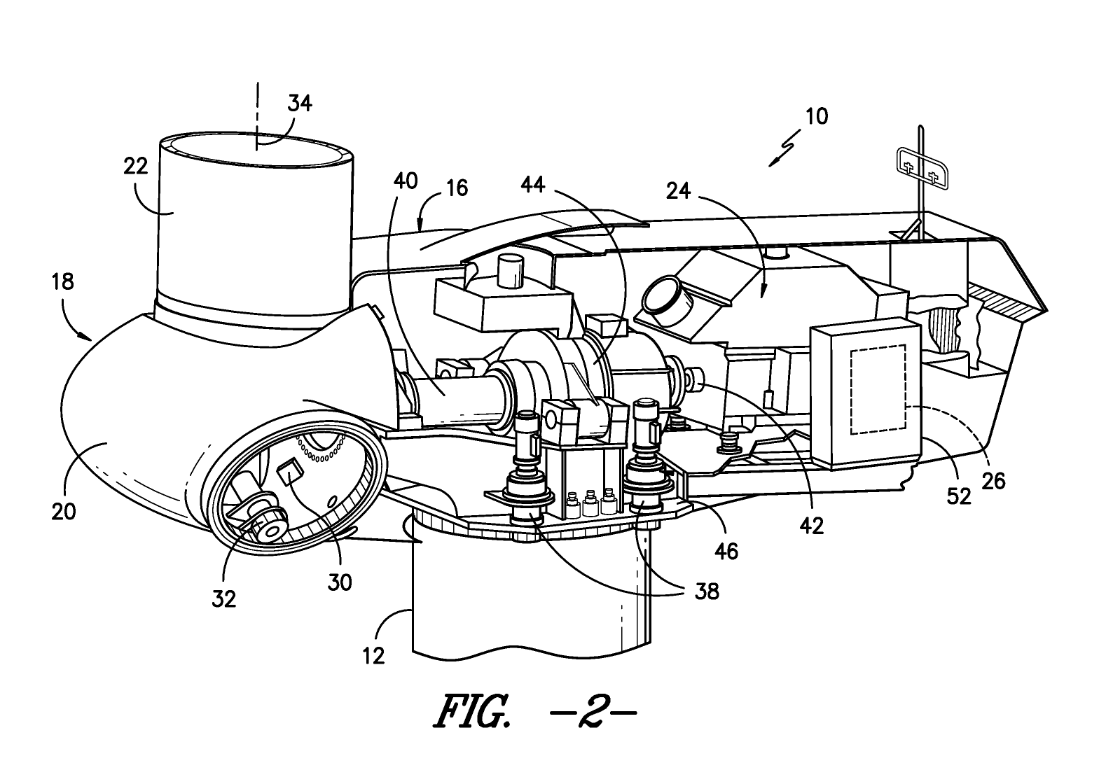

FIG. 1 illustrates a perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or a turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally be configured to control the various operating modes (e.g., start-up or shut-down sequences) and/or components of the wind turbine 10. For example, the controller 26 may be configured to control the blade pitch or pitch angle of each of the rotor blades 22 (i.e., an angle that determines a perspective of the rotor blades 22 with respect to the direction 28 of the wind) to control the loading on the rotor blades 22 by adjusting an angular position of at least one rotor blade 22 relative to the wind. For instance, the turbine controller 26 may control the pitch angle of the rotor blades 22, either individually or simultaneously, by transmitting suitable control signals/commands to a pitch controller 30 of the wind turbine 10, which may be configured to control the operation of a plurality of pitch drives or pitch adjustment mechanisms 32 (FIG. 2) of the wind turbine. Specifically, the rotor blades 22 may be rotatably mounted to the hub 20 by one or more pitch bearing(s) (not illustrated) such that the pitch angle may be adjusted by rotating the rotor blades 22 along their pitch axes 34 using the pitch adjustment mechanisms 32. Further, as the direction 28 of the wind changes, the turbine controller 26 may be configured to control a yaw direction of the nacelle 16 about a yaw axis 36 to position the rotor blades 22 with respect to the direction 28 of the wind, thereby controlling the loads acting on the wind turbine 10. For example, the turbine controller 26 may be configured to transmit control signals/commands to a yaw drive mechanism 38 (FIG. 2) of the wind turbine 10 such that the nacelle 16 may be rotated about the yaw axis 30.

It should be appreciated that the turbine controller 26 and/or the pitch controller 30 may generally comprise a computer or any other suitable processing unit. Thus, in several embodiments, the turbine controller 26 and/or pitch controller 30 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the turbine controller 26 and/or pitch controller 30 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the turbine controller 26 and/or pitch controller 30 to perform various computer-implemented functions. In addition, the turbine controller 26 and/or pitch controller 30 may also include various input/output channels for receiving inputs from sensors and/or other measurement devices and for sending control signals to various components of the wind turbine 10.

Referring now to FIG. 2, a simplified, internal view of one embodiment of the nacelle 16 of the wind turbine 10 is illustrated. As shown, a generator 24 may be disposed within the nacelle 16. In general, the generator 24 may be coupled to the rotor 18 of the wind turbine 10 for generating electrical power from the rotational energy generated by the rotor 18. For example, the rotor 18 may include a main rotor shaft 40 coupled to the hub 20 for rotation therewith. The generator 24 may then be coupled to the rotor shaft 40 such that rotation of the rotor shaft 40 drives the generator 24. For instance, in the illustrated embodiment, the generator 24 includes a generator shaft 42 rotatably coupled to the rotor shaft 40 through a gearbox 44. However, in other embodiments, it should be appreciated that the generator shaft 42 may be rotatably coupled directly to the rotor shaft 40. Alternatively, the generator 24 may be directly rotatably coupled to the rotor shaft 40 (often referred to as a “direct-drive wind turbine”).

It should be appreciated that the rotor shaft 40 may generally be supported within the nacelle by a support frame or bedplate 46 positioned atop the wind turbine tower 12. For example, the rotor shaft 40 may be supported by the bedplate 46 via a pair of pillow blocks 48, 50 mounted to the bedplate 46.

Additionally, as indicated above, the turbine controller 26 may also be located within the nacelle 16 of the wind turbine 10. For example, as shown in the illustrated embodiment, the turbine controller 26 is disposed within a control cabinet 52 mounted to a portion of the nacelle 16. However, in other embodiments, the turbine controller 26 may be disposed at any other suitable location on and/or within the wind turbine 10 or at any suitable location remote to the wind turbine 10. Moreover, as described above, the turbine controller 26 may also be communicatively coupled to various components of the wind turbine 10 for generally controlling the wind turbine and/or such components. For example, the turbine controller 26 may be communicatively coupled to the yaw drive mechanism(s) 38 of the wind turbine 10 for controlling and/or altering the yaw direction of the nacelle 16 relative to the direction 28 (FIG. 1) of the wind. Similarly, the turbine controller 26 may also be communicatively coupled to each pitch adjustment mechanism 32 of the wind turbine 10 (one of which is shown) through the pitch controller 30 for controlling and/or altering the pitch angle of the rotor blades 22 relative to the direction 28 of the wind. For instance, the turbine controller 26 may be configured to transmit a control signal/command to each pitch adjustment mechanism 32 such that one or more actuators (not shown) of the pitch adjustment mechanism 32 may be utilized to rotate the blades 22 relative to the hub 20.

As discussed above, during operation of a wind turbine 10, the wind turbine 10 may be subjected to various loads. In particular, due to the loads to which the wind turbine 10 is subjected, the rotor shaft 40 may be subjected to various loads. Such loads may include axial (or thrust) loads 90 and moment loads, which may include bending moment loads 92 and torsional loads 94. The axial loads 90 may occur generally along a longitudinal axis 98 of the shaft 40, and the bending loads 92 and torsional loads 94 may occur about the longitudinal axis 98.

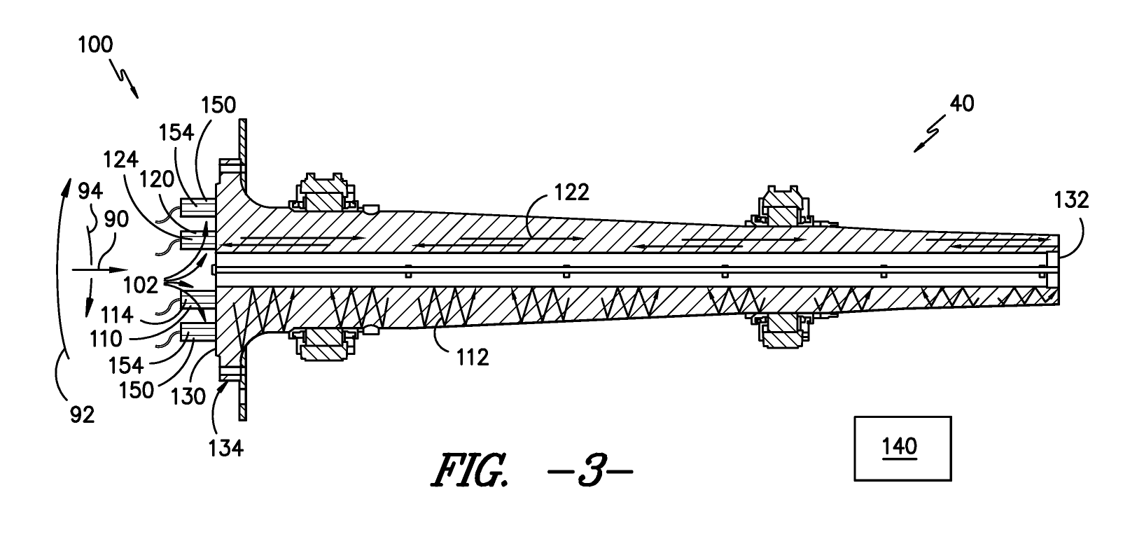

As discussed, improved systems and methods for controlling loads in wind turbines 10, and improved systems and methods for controlling shaft 40 loading, are desired in the art. Further, it should be understood that the present disclosure is not limited to rotor shafts 40 of wind turbines 10. Rather, any suitable shaft 40 is within the scope or spirit of the present disclosure. Thus, FIGS. 3 through 5 illustrate embodiments of a load control system 100, which may be utilized in a wind turbine 10. A load control system 100 may include, for example, a sensor assembly 102. The various components of the sensor assembly 102 may generally be mounted to the shaft 40, and may measure movement of the shaft due to moment loading thereof.

As shown, a sensor assembly 102 may include one or more ultrasonic probes 110, also referred to as first ultrasonic probes 110, mounted to the shaft 40. Each first ultrasonic probe 110 may be configured to produce one or more transverse ultrasonic waves 112 on the shaft 40, such as within and/or on the surface of the shaft 40. Thus, when mounted to the shaft 40, a transverse ultrasonic wave 112 produced by a probe 110 may travel on the shaft 40, such as through or along the shaft 40. In exemplary embodiments, as shown, the transverse ultrasonic wave 112 may travel on the shaft 40 generally along the longitudinal axis 98, in some embodiments a direction at an angle to the longitudinal axis 98. The angle may be, for example, less than approximately 90 degrees, such as in some embodiments less than approximately 70 degrees, such as in some embodiments between approximately 60 degrees and approximately 30 degrees, such as in some embodiments 0 degrees to the longitudinal axis 98.

As further shown, a sensor assembly 102 may include one or more receivers 114, also referred to as first receivers 114, mounted to the shaft 40. Each first receiver 114 may be configured to sense one or more transverse ultrasonic waves 112, such as those emitted from an associated first ultrasonic probe 110. Such sensing may generally occur after the transverse ultrasonic wave 112 has travelled on the shaft 40, such as generally along the longitudinal axis 98.

As shown, a sensor assembly 102 may further include one or more ultrasonic probes 120, also referred to as second ultrasonic probes 120, mounted to the shaft 40. Each second ultrasonic probe 120 may be configured to produce one or more longitudinal ultrasonic waves 122 on the shaft 40. Thus, when mounted to the shaft 40, a longitudinal ultrasonic wave 122 produced by a probe 120 may travel on the shaft 40. In exemplary embodiments, as shown, the longitudinal ultrasonic wave 122 may travel on the shaft 40 generally along the longitudinal axis 98, in a direction approximately parallel to the longitudinal axis 98.

As further shown, a sensor assembly 102 may include one or more receivers 124, also referred to as second receivers 124, mounted to the shaft 40. Each second receiver 124 may be configured to sense one or more longitudinal ultrasonic waves 122, such as those emitted from an associated second ultrasonic probe 120. Such sensing may generally occur after the longitudinal ultrasonic wave 122 has travelled on the shaft 40, such as generally along the longitudinal axis 98.

As shown, a sensor assembly 102 may further include one or more ultrasonic probes 150, also referred to as third ultrasonic probes 150, mounted to the shaft 40. Each third ultrasonic probe 150 may be configured to produce one or more mixed mode ultrasonic waves, such as Rayleigh waves or other suitable mixtures of ultrasonic wave modes, on the shaft 40. Thus, when mounted to the shaft 40, a mixed mode ultrasonic wave produced by a probe 150 may travel on the shaft 40. In exemplary embodiments, as shown, the longitudinal ultrasonic wave may travel on the shaft 40 generally along the longitudinal axis 98.

As further shown, a sensor assembly 102 may include one or more receivers 154, also referred to as third receivers 154, mounted to the shaft 40. Each third receiver 154 may be configured to sense one or more mixed mode ultrasonic waves, such as those emitted from an associated third ultrasonic probe 150. Such sensing may generally occur after the mixed mode ultrasonic wave has travelled on the shaft 40, such as generally along the longitudinal axis 98.

Both the ultrasonic probes 110, 120, 150 and the receivers 114, 124, 154 may be mounted to the shaft 40. For example, the ultrasonic probes 110, 120, 150 and the receivers 114, 124, 154 may be mounted through the use of suitable mechanical fasteners, such as nut-bolt combinations, rivets, screws, nails, brackets, etc., or may be welded or otherwise affixed, or may be otherwise suitably connected directly to the shaft 40. In some embodiments, an ultrasonic probe 110, 120, 150 and/or receiver 114, 124, 154 may include a base (not shown) mounted to the shaft, and to which the ultrasonic probe 110, 120, 150 and/or receiver 114, 124, 154 is mounted. Any suitable base may be utilized. In some embodiments, a base may be a wedge. Wedges may be utilized for the insonification of ultrasonic waves under an angle into a sample, such as into the shaft 40. In other embodiments, a base may be a delay. Delays may be utilized for the insonification of ultrasonic waves normal to the surface of a sample, such as into the shaft 40. Any suitable direct connection of an ultrasonic probe 110, 120, 150 and/or receiver 114, 124, 154 to a shaft 40, including the use of a base to mount an ultrasonic probe 110, 120, 150 and/or receiver 114, 124, 154, is within the scope and spirit of the present disclosure.

As shown, the transverse ultrasonic waves 112, longitudinal ultrasonic waves 122, and mixed mode ultrasonic waves may travel through the shaft 40 generally along the longitudinal axis 98 between a first end 130 of the shaft 40 and a second end 132 of the shaft 40. In exemplary embodiments as shown, the first end 130 is located at a hub flange 134 of the shaft 40, and the second end 132 is located at an end opposite to the hub flange 134. Alternatively, however, the first and second ends 130, 132 may be reversed or otherwise situated.

In some embodiments, transverse ultrasonic waves 112, longitudinal ultrasonic waves 122, and mixed mode ultrasonic waves may be produced at the first end 130 and sensed at the second end 132. The transverse ultrasonic waves 112, longitudinal ultrasonic waves 122, and mixed mode ultrasonic waves may thus travel through the shaft 40 from the first end 130 to the second end 132. In these embodiments, associated probes 110, 120, 150 and receivers 114, 124, 154 may be separate components, with the probes 110, 120, 150 mounted on the first end 130 and the receivers 114, 124, 154 mounted on the second end 132. In other embodiments, as shown in FIG. 3 through 5, transverse ultrasonic waves 112, longitudinal ultrasonic waves 122, and mixed mode ultrasonic waves may be produced at the first end 130 and sensed at the first end 130. The transverse ultrasonic waves 112, longitudinal ultrasonic waves 122, and mixed mode ultrasonic waves may thus travel through the shaft 40 from the first end 130 to the second end 132 and then from the second end 132 to the first end 130. In these embodiments, associated probes 110, 120, 150 and receivers 114, 124, 154 may be separate components, with the probes 110, 120, 150 mounted on the first end 130 and the receivers 114, 124, 154 mounted on the first end 130. Alternatively and as shown, however, associated probes 110, 120, 150 and receivers 114, 124, 154 may be singular components, included in a singular housing and/or built integrally with each other. Thus, for example, a probe 110, 120, 150 may include an associated receiver 114, 124, 154. In some embodiments, for example, an associated singular probe 110, 120, 150 and receiver 114, 124, 154 may be a transistor-receiver (“TR”) probe, a single element piezoelectric probe, or a polyvinylidene difluoride (“PVDF”) probe. Alternatively, direct contact probes, electromagnetic acoustic transducer (“EMAT”) probes or lasers which induce ultrasonic waves and associated receivers may be utilized.

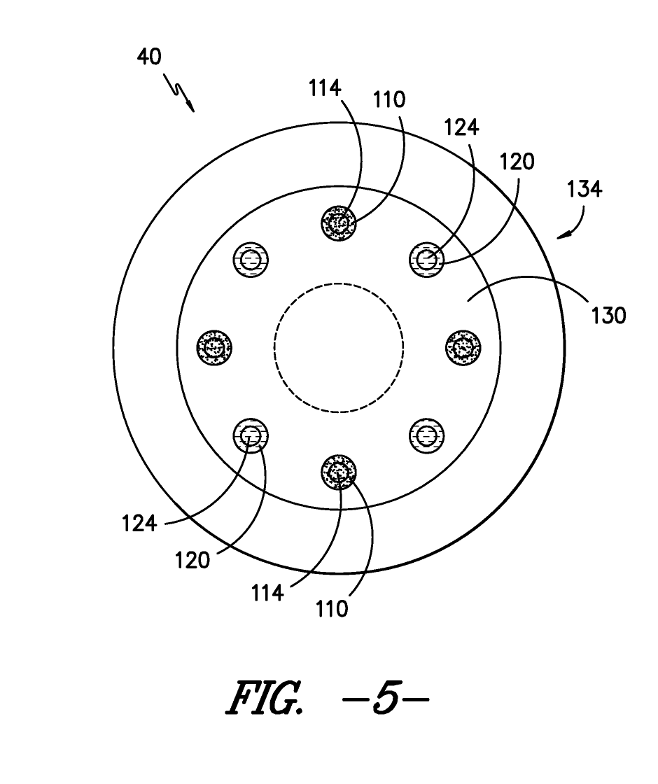

The plurality of probes 110, 120, 150 and receivers 114, 124, 154 may in some embodiments, as shown in FIG. 5, be disposed in generally annular arrays about the shaft 40. Further, the probes 110, 120, 150 and receivers 114, 124, 154 may be equally or unequally spaced apart in the annular array. Any suitable number of probes 110, 120, 150 and receivers 114, 124, 154 may be utilized in a sensor assembly 102 according to the present disclosure. While FIG. 5 illustrates one exemplary embodiment in which four first probe 110—first receiver 114 combinations and four second probe 120—second receiver 124 combinations are utilized, it should be understood that a sensor assembly 102 according to the present disclosure may include one, two, three, five, six or more first probes 110, first receivers 114, second probes 120, second receivers 124, third probes 150, and/or third receivers 154.

The transverse ultrasonic waves 112, longitudinal ultrasonic waves 122, and mixed mode ultrasonic waves produced by the probes 110, 120, 150 may be at any suitable frequency for calculating torsional loads and/or bending moment loads, as discussed below. In exemplary embodiments, the waves 112, 122 may be produced at a frequency between approximately 2 MHz and approximately 10 MHz, such as between approximately 2 MHz and approximately 5 MHz, such as between approximately 2 MHz and approximately 4 MHz. It should be understood that appropriate frequencies for required applications are materials dependent, and that any suitable frequency or range of frequencies for shafts 40 formed from any suitable materials are within the scope and spirit of the present disclosure.

As discussed, a sensor assembly 102 according to the present disclosure may include probes 110, 120, 150 and receivers 114, 124, 154 configured to respectively produce and sense transverse, longitudinal, and mixed mode ultrasonic waves 112, 122. The travel time of a wave 112, 122, which may be the time from production to sensing of a wave 112, 122, may relate to and be utilized to calculate the bending 92 and/or torsion 94 loading to which the shaft 40 is subjected. Thus, a load control system 100 according to the present disclosure may further include a controller 140. The controller 140 may be communicatively coupled to the sensor assembly 102, such as through a suitable wired or wireless connection. It should be understood that the controller 140 may have any suitable configuration as discussed above with respect to the controller 26, and in some embodiments may be combined with controller 26.

The controller 140 may be configured to determine a travel time of transverse ultrasonic waves 112, such as those waves 112 emitted by first ultrasonic probes 110. Thus, the controller 140 may determine the time between initial production of a wave 112 by a probe 110 and sensing of the wave 112 by an associated receiver 114. Additionally, the controller 140 may be configured to determine a travel time of longitudinal ultrasonic waves 122, such as those waves 122 emitted by second ultrasonic probes 120. Thus, the controller 140 may determine the time between initial production of a wave 122 by a probe 120 and sensing of the wave 122 by an associated receiver 124. Additionally, the controller 140 may be configured to determine a travel time of mixed mode ultrasonic waves, such as those waves emitted by third ultrasonic probes 150. Thus, the controller 140 may determine the time between initial production of a wave by a probe 150 and sensing of the wave by an associated receiver 154. Production and sensing information may thus be transmitted from the probes 110, 120, 150 and receivers 114, 124, 154 to the controller 140, and the controller may utilized this information to measure or otherwise determine the travel time for each wave 112, 122.

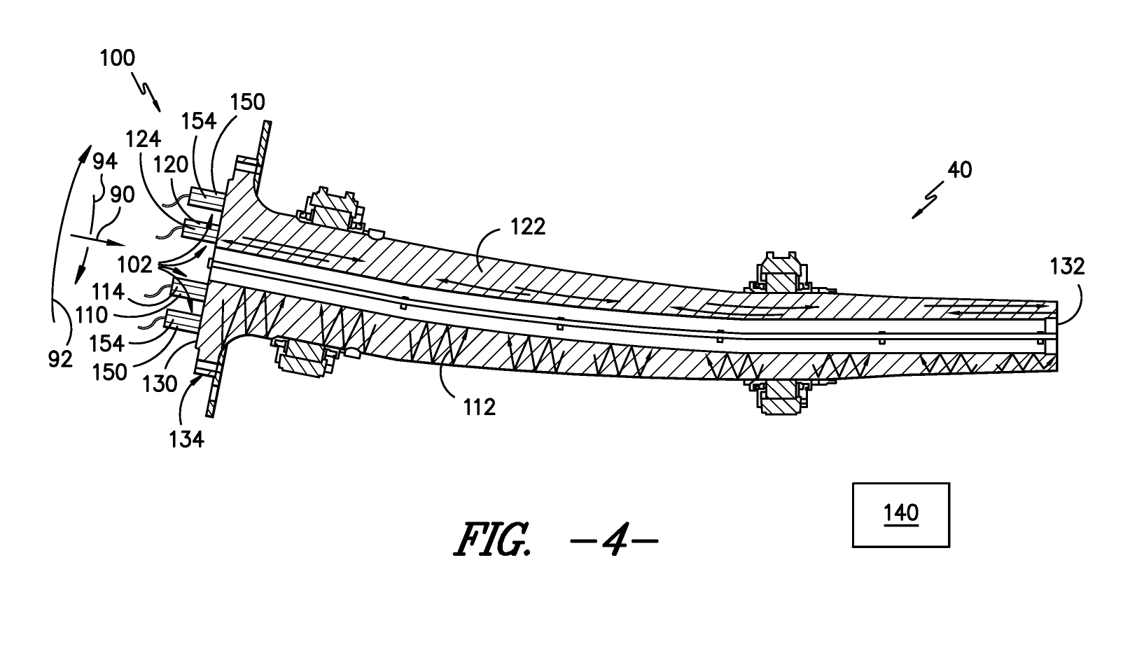

Further, the controller 140 may be configured to calculate a moment load, such as a bending 92 moment load or torsional 94 load, based on the travel time of an ultrasonic wave 112, 122. In particular, transverse ultrasonic waves 112 may be utilized to calculate torsional 94 loads, and longitudinal ultrasonic waves 122 may be utilized to calculate bending 92 moment loads. Mixed mode ultrasonic waves may be utilized to calculate one or both of torsional 94 loads and bending 92 moment loads. As shown in FIGS. 3 and 4 and as discussed above, a shaft 40 according to the present disclosure may, during operation of the wind turbine 10, experience bending moment loads and/or torsional loads. FIG. 3 illustrates a shaft 40 in a normal operating position and not subjected to bending moment loads and/or torsional loads. FIG. 4 illustrates a shaft 40 that is subjected to such bending moment loads and/or torsional loads. Due to bending and/or twisting of the shaft 40 when the shaft is experiencing such loading, the travel time for a wave 112, 122 under such loaded position may be different than, such as greater or less than, a nominal travel time for a wave 112, 122 in an unloaded position. The differences between the travel times of the various waves 112, 122 when the shaft 40 is in a loaded position and the nominal travel times of the various waves 112, 122 when the shaft 40 is in an unloaded position may thus be utilized to calculate the bending 92 moment load and/or torsional 94 load of the shaft 40.

With respect to torsional loading, transverse ultrasonic waves 112 may be utilized to calculate torsional loads. The travel time of one or more ultrasonic waves 112 produced by one or more probes 110 at a known frequency within the shaft 40 may be determined when the shaft 40 is in an unloaded position, to determine nominal travel times, and in the loaded position during operation of the wind turbine 10. The difference in travel times may then be utilized to determine the torsional load being experienced by the shaft 40. For example, the following equation may be utilized to relate the velocity of a wave to the shear modulus and the density of a material:

$${c}_{t} = \sqrt{\frac{R 1}{ρ 2 ( 1 + μ )}} = \sqrt{\frac{G}{ρ}}$$

wherein cₜ is the velocity of the transverse ultrasonic wave 112, E is the modulus of elasticity of the material, ρ is the density of the material, μ is Poisson's ratio, and G is the modulus of shear. This equation and/or other suitable equations may be utilized to calculate the torsional load of the shaft 40 based on the difference in travel times in the loaded and unloaded positions and based on the differences between travel times between various probe 110—receiver 114 combinations.

With respect to bending moment loading, longitudinal ultrasonic waves 122 may be utilized to calculate bending moment loads. The travel time of one or more ultrasonic waves 122 produced by one or more probes 120 at a known frequency within the shaft 40 may be determined when the shaft 40 is in an unloaded position, to determine nominal travel times, and in the loaded position during operation of the wind turbine 10. The difference in travel times may then be utilized to determine the bending moment load being experienced by the shaft 40. For example, the following equation may be utilized to relate the velocity of a wave to the shear modulus and the density of a material:

$${c}_{1} = \sqrt{\frac{E 1 - μ}{ρ ( 1 + μ ) ( 1 - 2 μ )}}$$

wherein cₗ is the velocity of the longitudinal ultrasonic wave 122, E is the modulus of elasticity of the material, ρ is the density of the material, and μ is Poisson's ratio. This equation and/or other suitable equations may be utilized to calculate the bending moment load of the shaft 40 based on the difference in travel times in the loaded and unloaded positions and based on the differences between travel times between various probe 120—receiver 124 combinations.

With respect to torsional and bending moment loading, mixed mode ultrasonic waves may be utilized to calculate one or both loads. The travel time of one or more ultrasonic waves produced by one or more probes 150 at a known frequency within the shaft 40 may be determined when the shaft 40 is in an unloaded position, to determine nominal travel times, and in the loaded position during operation of the wind turbine 10. The difference in travel times may then be utilized to determine the torsional and/or bending moment load being experienced by the shaft 40. For example, the following equation may be utilized to relate the velocity of a Rayleigh wave to the shear modulus and the density of a material:

$${c}_{R} = \frac{0.87 + 1.12 μ}{1 - μ} \sqrt{\frac{\begin{matrix}E & 1\end{matrix}}{ρ 2 ( 1 + μ )}}$$

wherein c_{R} is the velocity of the Rayleigh ultrasonic wave, E is the modulus of elasticity of the material, ρ is the density of the material, and μ is Poisson's ratio. This equation and/or other suitable equations may be utilized to calculate the torsional and/or bending moment load of the shaft 40 based on the difference in travel times in the loaded and unloaded positions and based on the differences between travel times between various probe 110—receiver 114 combinations.

In this manner, the controller 140 may be configured to calculate the torsional load and/or bending moment load of the shaft 40 based on the travel time of the transverse ultrasonic waves 112, longitudinal ultrasonic waves 122, and/or mixed mode ultrasonic waves. Further, in some embodiments, the controller 140 may additionally or alternatively be configured to adjust an operational parameter of the wind turbine 10 based on the travel time of the transverse ultrasonic waves 112, longitudinal ultrasonic waves 122, and/or mixed mode ultrasonic waves. Adjustment may be based directly on the travel time of the transverse ultrasonic waves 112, longitudinal ultrasonic waves 122, and/or mixed mode ultrasonic waves or may be based on the calculated torsional loads and/or bending moment loads as discussed above. Operational parameters include, for example, pitch and/or yaw, as discussed above. Thus, the controller 140 may be in communication with or combined with the controller 26. Such adjustment of the operational parameters may adjust, such as desirably reduce, the loading on the shaft 40. For example, pitch and/or yaw may be adjusted to reduce loading, and in particular bending 92 and/or torsional 94 loading, on the shaft 40, as desired or required during operation of the wind turbine 10.

In some embodiments, the controller 140 may be configured to adjust operational parameters of the wind turbine 10 according to a constant feedback loop or at predetermined increments. Thus, the controller 140 may include suitable software and/or hardware for constantly or incrementally monitoring and calculating moments in real-time, and for adjusting operational parameters as required in order for such moments to be maintained within a predetermined window or above or below a predetermined minimum or maximum amount.

The present disclosure is further directed to methods for controlling wind turbine 10 loading. Such methods include, for example, producing one or more transverse ultrasonic waves 112, longitudinal ultrasonic waves 122, and/or mixed mode ultrasonic waves such as at a first end 130 of a shaft 40 as discussed above. Such methods may further include sensing the transverse ultrasonic waves 112, longitudinal ultrasonic waves 122, and/or mixed mode ultrasonic waves such as at a first end 130 or a second end 132 of a shaft 40 as discussed above. Such methods may further include, with respect to the transverse ultrasonic waves 112 and/or mixed mode ultrasonic waves, calculating a torsional load experienced by the shaft 40 based on travel times of the transverse ultrasonic waves 112 and/or mixed mode ultrasonic waves. Further, such methods may include, with respect to the longitudinal ultrasonic waves 122 and/or mixed mode ultrasonic waves, calculating a bending moment load experienced by the shaft 40 based on travel times of the longitudinal ultrasonic waves 122 and/or mixed mode ultrasonic waves. Still further, in some embodiments, a method may include adjusting an operational parameter of the wind turbine 10, such as pitch and/or yaw, based on the travel time of the transverse ultrasonic waves 112, longitudinal ultrasonic waves 122, and/or mixed mode ultrasonic waves, such as discussed above for example.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A load control system for a shaft, comprising:
a sensor assembly, the sensor assembly comprising:
a plurality of ultrasonic probes mounted to the shaft, each of the plurality of ultrasonic sensors configured to produce an ultrasonic wave on the shaft; and
a plurality of receivers mounted to the shaft, each of the plurality of receivers configured to sense the ultrasonic wave produced by one of the plurality of ultrasonic probes; and
a controller communicatively coupled to the sensor assembly and configured to measure a travel time of the ultrasonic wave produced by each of the plurality of ultrasonic probes.

2. The load control system of claim 1, wherein each of the plurality of ultrasonic probes comprises one of the plurality of receivers.

3. The load control system of claim 2, wherein each of the plurality of ultrasonic probes is a single element piezoelectric ultrasonic probe.

4. The load control system of claim 1, wherein the plurality of ultrasonic probes and the plurality of receivers are mounted to a first end of the shaft.

5. The load control system of claim 4, wherein the shaft comprises a hub flange, and wherein the hub flange comprises the first end.

6. The load control system of claim 1, wherein the ultrasonic wave is produced at a frequency between approximately 2 MHz and approximately 10 MHz.

7. The load control system of claim 1, wherein the ultrasonic wave is a transverse ultrasonic wave.

8. The load control system of claim 1, wherein the ultrasonic wave is a longitudinal ultrasonic wave.

9. The load control system of claim 1, wherein the controller is configured to calculate shaft torsional load based on the travel time of the ultrasonic wave.

10. The load control system of claim 1, wherein the controller is configured to calculate shaft bending moment load based on the travel time of the ultrasonic wave.

11. The load control system of claim 1, wherein the plurality of ultrasonic probes are generally equally spaced apart from one another in a generally annular array.

12. A wind turbine, comprising:
a tower;
a nacelle mounted to the tower;
a rotor coupled to the nacelle, the rotor comprising a hub and a plurality of rotor blades;
a generator;
a rotor shaft extending between the rotor and the generator; and
a sensor assembly, the sensor assembly comprising:
a plurality of ultrasonic probes mounted to the rotor shaft, each of the plurality of ultrasonic sensors configured to produce an ultrasonic wave on the rotor shaft; and
a plurality of receivers mounted to the rotor shaft, each of the plurality of receivers configured to sense the ultrasonic wave produced by one of the plurality of ultrasonic probes; and
a controller communicatively coupled to the sensor assembly and configured to measure a travel time of the ultrasonic wave produced by each of the plurality of ultrasonic probes.

13. The wind turbine of claim 12, wherein the ultrasonic wave is a transverse ultrasonic wave.

14. The wind turbine of claim 12, wherein the ultrasonic wave is a longitudinal ultrasonic wave.

15. A method for controlling wind turbine loading, the method comprising:
producing an ultrasonic wave at a first end of a rotor shaft;
sensing the ultrasonic wave; and
calculating a rotor shaft torsional load based on a travel time of the ultrasonic wave.

16. The method of claim 15, wherein the ultrasonic wave is a transverse ultrasonic wave.

17. The method of claim 15, wherein the ultrasonic wave is a longitudinal ultrasonic wave.

18. The method of claim 15, wherein the sensing step occurs at the first end of the rotor shaft.

19. The method of claim 15, further comprising adjusting an operational parameter of the wind turbine based on the travel time of the ultrasonic wave.
